(19) United States
(12) Patent Application Publication
(10) Pub. No.: US 2008/0260160 A1
(43) Pub. Date: Oct. 23, 2008

(54) Opt-in process and nameserver system for IETF DNSSEC

(75) Inventor: Thierry Moreau, Montreal (CA)

Correspondence Address: Mr. Thierry Moreau, 9130 Place de Montgolfier, Montreal, QC, H2M 2A1, CA

(73) Assignee: CONNOTECH Experts-conseils inc., Montreal (CA)

(21) Appl. No.: 12/148,447

(22) Filed: Apr. 18, 2008

(30) Foreign Application Priority Data
Apr. 19, 2007 (CA) 2,586,223

(51) Int. Cl. H04L 9/30; G06F 21/00

(52) U.S. Cl. 380/277; 380/30

(57) ABSTRACT

The process of signing and then publishing a DNS zone according to the IETF DNSSEC protocols is improved by the present invention, in order to facilitate the DNSSEC deployment until most of the DNS zones are signed. The prior art situation is that a second-level domain, e.g. example.com, often faces an unwanted status of “DNSSEC island of security,” and a challenging task of “trust anchor key” out-of-band distribution. The invention somehow fixes such broken DNSSEC chains of trust, e.g. it fills the gap between a DNSSEC island of security and its signed grandparent or ancestor. The invention is deemed useful for the introduction of DNS root nameservice substitution for DNSSEC support purposes, and allows opt-in while NSEC3 opt-out is awaiting deployment in large TLDs.

### BACKGROUND OF THE INVENTION

The IETF DNSSEC protocol extension to the Domain Name System is an IT security application scheme for public key cryptography, of comparable significance with the PKI model characterized by security certificates, and the PGP model characterized by its web of introducers. See Internet RFC4033, RFC4034, and RFC4035. DNSSEC is characterized by trust transition by digital signatures organized along the domain name hierarchy (actually, it's the DNS zone hierarchy as explained below). Hence, the DNSSEC public key digital signature for the DNS root becomes a focal point of attention, and large TLDs (Top Level Domain) such as .com also become critical resources to commit for large-scale DNSSEC deployment.

A DNS zone is a contiguous segment of the DNS name hierarchy that is managed by a single entity, where entity encompasses coordinated authoritative DNS nameservers and one DNS zone management organization. A DNS zone has a zone apex, like a local root in the domain name hierarchy, where public signature keys for the zone are registered, individually in DNSKEY RR (Resource Records), and collectively in the zone apex DNSKEY RRset (Resource Record Set). For DNSSEC purposes, DNS RR entries for the same type (e.g. A for IPv4 addresses, AAAA for IPv6 addresses, DNSKEY for a zone public key, . . . ) and associated with the same domain name are grouped in an RRset for digital signature purposes. A DNSSEC digital signature applies to a single complete RRset for a domain name and RR type; it is encoded as an RRSIG RR. Obviously RRSIG RRs themselves are not grouped in a signed RRset for a domain name and the RRSIG type because this would create recursion and ambiguity about what is actually signed.

The above paragraph gives an overview of the DNSSEC signing process for a signed DNS zone. Unsigned DNS zones are devoid of RRSIG, NSEC, and NSEC3 RRs and are normally devoid of DS and/or DNSKEY RRs also. The signing process enforces a discipline in the DNS zone contents management because the signed zone data can not be modified without causing DNSSEC validation errors.

For a signed zone, the DNS publishing process follows the DNSSEC signature process. DNS publishing is achieved by loading (either in batch or incrementally or differentially) the DNS zone file contents in the memory (or cache or database) of one or more authoritative DNS nameserver and allowing these nameservers to respond to DNS queries with DNS responses through a network interface.

A DNSSEC-aware authoritative nameserver system is the foremost tool for DNS zone publishing when the zone is signed. Typically, it comprises the required computer equipment, software such as the well-know BIND software (Berkeley Internet Name Domain), database or indexing back-ends, and one or more network interfaces connected to the public Internet or another IP network. A nameserver is available form the IP network to which it is connected through its IPv4 and/or IPv6 address, which can be embedded in a URL. With a computer connected to the same IP network and using readily available software tools such as the “dig” utility distributed with the BIND software, it is convenient to perform ad-hoc real-time queries of the DNS data published in a zone by a nameserver at a given moment, starting with the knowledge of the DNS domain name of interest and the IPv4 or IPv6 address of the nameserver.

Since a given zone is typically served by more than one nameserver, an issue of synchronization arises, compounded by additional synchronization requirements of specific DNS zone data with the zone parent and zone children in the DNS hierarchy. Accordingly, transient and temporary inconsistencies in the DNS are tolerated as a fact of life and the notion of “concurrent publishing” between related nameservers or DNS zones has to be understood with these temporal inconsistencies.

The best equivalent to a PKI security certificate in the DNSSEC protocols is the DNS zone “secure delegaton” from a parent zone to a child zone. A secure delegation is made of 1) a public key signature, encoded as an RRSIG RR, authenticating the child zone DNSKEY RRset by one of the key present in the DNSKEY RRset, 2) a hash fingerprint of the DNSKEY RR for this signature key, the hash being registered in the parent zone in a DS RR in association with the child zone apex domain name (which is by necessity below the parent zone apex), and 3) a public key signature in the parent zone, encoded as an RRSIG RR like any other DNSSEC digital signature, authenticating the DS RRset for the child zone. A secure delegation to a signed zone requires the parent zone to be signed.

The prior art process called DNSSEC validation, or simply validation in the context of DNSSEC specifications, refers to a DNS resolver that verifies digital signatures among the DNS responses received from DNS nameservers, or cached from previous DNS responses. The complete DNS validation is usually triggered by a given DNS service request by a web browser or an application. The DNS validating resolver then verifies a chain of digital signatures, including validation of secure delegation at DNS zone cuts, starting from the domain name in the service request and upwards in the DNS zone hierarchy up to either the DNS root, or a DNS zone for which public keys are trusted, or a DNS zone having an unsigned parent. Within a single DNS zone, a link of the chain may be an RRset signed by a signature key ABC, the latter being present in the DNSKEY RRset at the zone apex, the latter being signed by signature key DEF also present in the DNSKEY RRset. In this example, the key DEF “certifies” the key ABC and may further be involved in a secure delegation from the zone parent.

By itself, the very complexity of DNSSEC is not the foremost challenge of DNSSEC deployment. Reaching a critical mass of deployment requires the commitment to DNSSEC by the zone management organizations around the top of the DNS hierarchy, in addition to support by DNS resolvers, and also applications in some usage scenarios. This turns into a clear chicken-and-egg issue in reaching a critical mass of deployed components.

In DNSSEC terminology, when a zone is signed, i.e. DNSSEC-enabled, and its parent is not, the domain is an “island of security” The issue of incomplete DNSSEC support within the DNS hierarchy has been addressed by a scheme called DLV, which is a repository for trust anchors separate from the mainstream DNS hierarchy, however accessible through modified DNS resolver software logic. See Internet RFC4431. However, the DLV scheme requires a DLV operator to provision systems to answer DNS queries from the public Internet, and as such is potentially exposed to enormous traffic growth.

Very pragmatically, the TLD zone managers under contract with ICANN as the DNS root manager are seldom free to charge extra money for establishing and maintaining secure delegations in the TLD registry (another term for the TLD zone and its computer infrastructure for registering DNS domain names). Nowadays, the DNSSEC technology is invalidated by the lack of a business model for this foremost category of participants.

Another intriguing aspect of the DNSSEC protocol is its relationship with what is known as “alternate DNS roots.” A single DNS root has been strongly advocated primarily for issues of 1) coordination of introduction of IDN (Internationalized Domain Names), 2) avoidance of discrepancies in the Internet end-user view of the DNS root zone contents, and 3) the difficulty of configuration management for hundred of thousands DNS resolvers which must know the IP addresses of the DNS root nameservers. See Internet RFC2826. With DNSSEC, the last item seems compounded by the addition of root trust anchor key in the required configuration.

Actually, an alternate DNS root operation for the sole purpose of DNSSEC support is technically simple. The present inventor refers to such an undertaking as “DNS root nameservice substitution for DNSSEC support purposes” or simply “DNS root nameservice substitution” This is facilitated by the wide availability of the exact DNS root zone file contents, on a timely basis with respect to change schedule, thus avoiding root zone file discrepancies.

By itself, DNS root nameservice substitution has the potential to solve a major obstacle towards DNSSEC deployment. However, two difficulties arise: 1) a scaling problem with a public root nameservice that is likely to be overflowed by traffic surge if technically reliable, and 2) the resolver configuration issue.

The present inventor makes a new and useful contribution to the prior art, concurrently with the present invention, by applying the teachings of the IETF SLP (Service Location Protocol) disclosure to the task of deployment and management of DNS root nameservice substitution. The SLP concept is similar to the well understood DHCP, but on a broader scope called an administrative domain (not to be confused with a DNS domain), and with protocol standardization of authentication with digital signatures (SLP allows digital signatures of service announcements, including URLs and service attributes). By assigning the SLP UA (User Agent) role to a DNS resolver, the SLP disclosure opens the door to selective deployment of DNS root nameservice substitution within an administrative domain. Thus, the SLP scheme directly addresses the DNS resolver configuration issue. If a large corporation ABC sets up a DNS root nameservice substitution with the assistance of SLP and the word spreads that it went smoothly, other organizations will do the same, primarily targeting their respective user base, and no single undertaking will be exposed alone to the global scaling problem. For this purpose, the DNS root zone file signing can be made by a consortium, with the nameservice operation being left to each member.

Yet another challenging aspect of DNSSEC deployment is caused by the large size of some TLD zones. For these, the DNSSEC security service called “authenticated denial of existence of DNS data,” and implemented with either the NSEC or NSEC3 RR type, brings a significant processing overhead. This led to a tweaking of the specification called NSEC3 opt-out in the latest DNSSEC protocol documents. See the Internet draft draft-ieff-dnsext-nsec3-10 entitled “DNSSEC Hashed Authenticated Denial of Existence” expected to be published also as an Internet RFC. Indeed, any incomplete implementation of the DNSSEC specification is deemed to reduce the scope and/or effectiveness of its security services.

It thus remains problematic that the DNSSEC deployment is limited by important unsigned DNS zones near the top of the domain name hierarchy.

### BRIEF SUMMARY OF THE INVENTION

While the prior art efforts focused on direct operational support of trust anchors for DNSSEC islands of security, the present invention aims at facilitating DNSSEC deployment by bridging the gap between a signed child zone and a signed grandparent zone, or a signed higher generation ancestor zone, when the immediate parent zone is unsigned. Like NSEC3 opt-out, the present invention opt-in strategy decreases the comprehensiveness of DNSSEC security services in favor of easier deployment path. A common public signature key value is used for trust transition between two signed DNS zones.

### NO DRAWING

No drawing is provided; the present invention seems not conveniently and not constructively represented in a drawing.

### DETAILED DESCRIPTION OF THE INVENTION

A public signature key is a numeric value, or small set of values, irrespective of its encoding as an ASN.1 string which affixes algorithm indications and base 64 encoding and the like. In the context of the present invention, a public signature key is not systematically associated with its “owner” as is typical in academic literature (“Alice's public key . . . ”) and in most security protocol encoding specifications, e.g. an X.509 certificate. Notably, the invention uses a common public signature key value in two DNSKEY RRsets, in respective DNS zone apexes identified by different, and perhaps unrelated, DNS domain names.

In spite of the above, the inventive use of a common public signature key value remains secure and useful for DNSSEC validation purposes. First, because the private counterpart remains under control by an entity. Second, because it is inserted in the DNSKEY RRset of at least one DNS zone apex where it is normally validated by regular DNSSEC validation rules, e.g. a signed DNS root in a preferred embodiment.

Any DNSSEC zone administrator may insert a public signature key value in the DNSKEY RRset of its zone apex. The present invention suggests a DNS operational practice where the zone manager of e.g. example.com a) inserts the common public signature key value in the DNSKEY RRset of its zone apex, and b) has a portion of its zone file signed by the private key controlling entity. The zone administrator can do this irrespective of the DNSSEC island of security characterization and irrespective of the trust anchor distribution through DLV or out-of-band.

It is thus possible, reasonable, and legitimate for a DNSSEC validator to accept the signatures based on the common public signature key value in the second zone (example.com) from its acceptance elsewhere in the domain name hierarchy, e.g. in a signed DNS root of a preferred embodiment. Such a validation process overcomes the fact that an intermediate zone, e.g. .com, is DNSSEC-oblivious.

It should be obvious that the common public signature key value must be validated at least once using prior-art-specifications-compliant DNSSEC validation. This observation suggests an advantageous use where the common public signature key value is present in the DNSKEY RRset of a DNS rot zone apex, either from IANA or in the context of DNS root nameservice substitution.

In an example of the use of the present invention, the key controlling entity has the opportunity to have the common key included in the DNSKEY RRset at the DNS root zone apex, with a signed root, and the key controlling entity operates as a secure delegation service provider according to the present invention security scheme. The common key and/or the key controlling entity may or may not be involved in the root signing process. The manager of a second-level domain DNS zone, e.g. example.com, prepares a DNSKEY RRset including its own key(s) and the common public signature key. This second-level domain manager may sign the DNSKEY RRset with one or more of its private keys, and in all cases the key controlling entity signs the DNSKEY RRset with the common key private counterpart (credentials are presented by the second-level domain manager to the key controlling entity as is well-known for security delegation provisioning). While keeping these signatures, the second-level domain zone signing proceeds normally to add other signatures to the zone data according to the DNSSEC specifications, and the subsequent zone publishing is otherwise operationally identical to the prior art. It should be clear that if the TLD zone launches DNSSEC support at a later time, a prior-art DNSSEC secure delegation from the TLD zone may quietly supersede the inventive secure delegation from the key controlling entity. Many variations of this usage example are possible.

A specific use of the present invention is for authenticating the IPv4 and/or IPv6 addresses of DNS root nameservers in the context of DNSSEC deployment. The difficulty is that the domain names for the relevant A and/or AMAA RRsets may reside in DNS zone(s) which are not resolvable, e.g. in an island of security. For this use, the common signature public key should be in the DNSKEY RRsets at both the root zone and any of zone containing the domain names for the relevant authoritative A and/or AAAA RRsets, the latter being called “root nameserver authoritative addressing RRsets.” Someone knowledgeable of the field may work out the details for the two solutions, respectively in which the non-root zone apex DNSKEY RRset must be signed with the common key, and in which the relevant authoritative A and/or AAAA RRsets must be signed with the common key.

The present disclosure encompasses an inventive DNSSEC validation algorithm, in the form of an improvement over the prior art validation algorithm. Simply stated, whenever the prior art algorithm is puzzled about accepting an RRSIG RR signature that has been mathematically verified with one of the public keys present in the local zone apex, it may accept the signature if the same public signature key value has been accepted for a different zone name, based on a trust anchor acceptable for the current validation context. As a matter of detail, the DNSSEC encoding specification for a “key tag” is not an appropriate basis to conclude that two key values are equal or not (e.g. if the DNSKEY RR representation of the key has the SEP bit set in one zone but not in the other). Since a broken link in the chain of digital signature may prevent the prior art validation algorithm from actually querying the zone where the common key might be accepted, the inventive algorithm should attempt a reverse direction validation. Alternately, assuming the present invention is practiced with a root-centric strategy on the nameserver side of the DNS, the candidate set of potential common key values may be arbitrarily set at the DNSKEY RRset at the root.

In general, the data published in the DNS is used with a large degree of freedom by computers and software applications connected to the Internet or private IP networks. The DNSSEC protocol specifications include resolver behavior provisions for computing a global security status (secure, insecure, bogus, or indeterminate) from observed DNS responses, i.e. turning comprehensive data into summary data. The global security status is more useful when it is other than indeterminate. The present invention allows resolvers to come up with a useful global security status more often if they implement the inventive DNSSEC validation algorithm, to the extent that the DNS includes published data according to the present invention. It is thus obvious for any conceivable application of DNSSEC to benefit from the present invention, merely by upgrading the DNSSEC validation algorithm with the inventive one.

The technical details of the possible use of SLP with the DNS root are contained in the initial revision (00) of an Internet draft draft-moreau-srvloc-dnssec-priming-00.txt entitled “DNSSEC Validation Root Priming Through SLP (DNSSEC-ROOTP),” this draft being included herein by reference.

Thus, a general purpose of the invention is to provide a process of DNSSEC publishing a signed DNS zone (target zone) with a public signature key value in the DNSKEY RRset at its apex that is also present in the DNSKEY RRset at the apex of a second DNS zone (reference zone), the two zones being published concurrently, and the target zone having at least one signed RRset signed (with an RRSIG RR) using this same public signature key value, and where the private counterpart of this public signature key is controlled by an entity.

Another general purpose of the invention is to provide a DNSSEC-aware authoritative nameserver system where a served DNS zone (target zone) has a public signature key value in the DNSKEY RRset at its apex that is also present in the DNSKEY RRset at the apex of a second DNS zone (reference zone), the two zones being published concurrently, and the target zone having at least one signed RRset signed (with an RRSIG RR) using this same public signature key value, and where the private counterpart of this public signature key is controlled by an entity.

In a variant of the present invention, the reference zone is higher in the DNS zone hierarchy than the target zone's parent, i.e. there is at least one intervening zone between the target and the reference zone and the latter is closer to the DNS root. In a further variant, at least one of the intervening zone(s) is unsigned, or at least it is published without DNSSEC support concurrently with the target zone.

In yet another variant of the present invention, the reference zone is a DNS root.

In a focused variant of the present invention, the reference zone is a DNS root, the target zone apex DNSKEY RRset is signed with an RRSIG RR using the public signature key value, and the target zone contains at least one root nameserver authoritative addressing RRset.

In an equally focused variant of the present invention, the reference zone is a DNS root, the target zone contains at least one root nameserver authoritative addressing RRset, and said root nameserver authoritative addressing RRset(s) is(are) signed with an RRSIG RR using the public signature key value.

In yet another variant of the present invention, the target zone apex DNSKEY RRset is signed with an RRSIG RR using the public signature key value.

In yet another variant of the present invention, the DNSSEC-aware authoritative nameserver system has a network interface referenced by a URL advertized by a service agent compliant to the IETF service location protocol.

While the present invention disclosure uses the DNSEXT specification as a terminology base as a matter of convenience and clarity, it is referring to the functional aspects of the protocol and security elements, and it is not limited to an embodiment in the current DNSEXT protocol specification. Unforeseen developments in the DNSSEC protocol may occur, as exemplified by precedents in the DNS evolution, i.e. KEY RR was superseded by the DNSKEY RR with similar functionality, and the NSEC RR was given the companion NSEC3 RR mainly for adding a privacy protection aspect missing in the original NSEC RR scheme. Moreover, the spirit of the present invention is independent of the current DNSSEC limitation that a RRSIG RR signature covers the complete RRset for a given domain name and RR type. Or any DNSSEC limitation that zone signing keys appear at the zone apex. Or the DNSSEC limitation on affixing attributes to signing keys (the present invention could make use of a hint bit for OPTIN like the hint bit labeled SEP in the DNSKEY RR encoding). Also, the present invention would be readily adapted by someone knowledgeable of the art to a loosely coupled directory service secured with digital signatures overlaid on a namespace hierarchy similar to DNSSEC.

What is claimed is:

1. A process of DNSSEC publishing a signed first DNS zone where a public signature key value in the DNSKEY RRset at the apex of said first DNS zone is present in the DNSKEY RRset at the apex of a second DNS zone, where said second DNS zone is published concurrently with said first DNS zone, where at least one signed RRset in said first DNS zone is signed with an RRSIG RR using said public signature key value, and where the private counterpart of said public signature key is controlled by an entity.

2. A process as in claim 1 where said DNSKEY RRset at the apex of said first DNS zone is signed with an RRSIG RR using said public signature key value.

3. A process as in claim 1 where said second DNS zone is higher in the DNS zone hierarchy than the parent of said first DNS zone.

4. A process as in claim 3 where said DNSKEY RRset at the apex of said first DNS zone is signed with an RRSIG RR using said public signature key value.

5. A process as in claim 3 where at least one DNS zone above said first DNS zone and below said second DNS zone in the DNS zone hierarchy is published without DNSSEC support concurrently with said first DNS zone.

6. A process as in claim 1 where said second DNS zone is a DNS root.

7. A process as in claim 6 where said DNSKEY RRset at the apex of said first DNS zone is signed with an RRSIG RR using said public signature key value.

8. A process as in claim 7 where said first DNS zone contains at least one root nameserver authoritative addressing RRset.

9. A process as in claim 6 where said first DNS zone contains at least one root nameserver authoritative addressing RRset, and where each said at least one root nameserver authoritative addressing RRset is signed with an RRSIG RR using the public signature key value.

10. A DNSSEC-aware authoritative nameserver system where a served DNS zone has a public signature key value in the DNSKEY RRset at the apex of said served DNS zone occurring in the DNSKEY RRset at the apex of a second DNS zone, where said second DNS zone is published concurrently with said first served DNS zone, where at least one signed RRset in said served DNS zone is signed with an RRSIG RR using said public signature key value, and where the private counterpart of said public signature key is controlled by an entity.

11. A nameserver system as in claim 10 where said DNSKEY RRset at the apex of said served DNS zone is signed with an RRSIG RR using said public signature key value.

12. A nameserver system as in claim 10 where said second DNS zone is higher in the DNS zone hierarchy than the parent of said served DNS zone.

13. A nameserver system as in claim 12 where said DNSKEY RRset at the apex of said served DNS zone is signed with an RRSIG RR using said public signature key value.

14. A nameserver system as in claim 12 where at least one DNS zone above said served DNS zone and below said second DNS zone in the DNS zone hierarchy is published without DNSSEC support concurrently with said served DNS zone.

15. A nameserver system as in claim 10 where said second DNS zone is a DNS root.

16. A nameserver system as in claim 15 where said DNSKEY RRset at the apex of said served DNS zone is signed with an RRSIG RR using said public signature key value.

17. A nameserver system as in claim 16 where said served DNS zone contains at least one root nameserver authoritative addressing RRset.

18. A nameserver system as in claim 15 where said served DNS zone contains at least one root nameserver authoritative addressing RRset, and where each said at least one root nameserver authoritative addressing RRset is signed with an RRSIG RR using the public signature key value.

19. A nameserver system as in claim 15 having a network interface referenced by a URL advertized by a service agent compliant to the IETF service location protocol.
